(19) United States
(12) Patent Application Publication
(10) Pub. No.: US 2011/0091084 A1
(43) Pub. Date: Apr. 21, 2011

(54) AUTOMATIC OPACITY DETECTION SYSTEM FOR CORTICAL CATARACT DIAGNOSIS

(76) Inventors: Huiqi Li, Terrace (SG); Joo Hwee Lim, Terrace (SG); Jiang Liu, Terrace (SG); Li Liang Ko, Terrace (SG); Wing Kee Damon Wong, Terrace (SG); Tien Yin Wong, Snec Building (SG)

(21) Appl. No.: 12/993,751

(22) PCT Filed: May 20, 2008
(86) PCT No.: PCT/SG08/00190

§ 371 Date: Nov. 19, 2010

(51) Int. Cl. G06K 9/00

(52) U.S. Cl. 382/128

(57) ABSTRACT

A method performed by a computer system for detecting opacity in an image of the lens of an eye. The method includes detecting a region of interest in a picture of the lens, and processing the region of interest to produce a modified image using an algorithm which emphasizes opacity associated with a cortical cataract relative to opacity caused by other types of opacity, such as opacity caused by posterior sub-capsular cataracts (PSC). The modified image may be used for grading the level of cortical opacity, by measuring, in the modified image, the proportion of opacity in at least one area of the region of interest.

### FIELD OF THE INVENTION

The present invention relates to an automatic opacity detection system, having method and apparatus aspects. The system can be used to obtain a grading value for opacity due to cortical cataracts (“cortical opacity”), for example to perform cortical cataract diagnosis.

### BACKGROUND OF THE INVENTION

Cataracts are the leading cause of blindness worldwide. It has been reported that 47.8% of global blindness is caused by cataracts [1], and 35% of Singapore Chinese people over 40 years old are reported to have cataracts [2]. A cataract is due to opacity or darkening of crystalline lens. According to some studies [3]-[4], the most prevalent type of cataracts are cortical cataracts which begin as whitish, wedge-shaped opacities or streaks on the outer edge cortex (or periphery) of the lens, and as they slowly progress, the streaks extend to the center and interfere with light passing through the center of the lens. By contrast, a sub-capsular cataract starts as a small, opaque area usually near the back of the lens in the path of light on the way to the retina.

Retro-illumination images are taken for grading of cortical and sub-capsular cataracts. Conventionally, ophthalmologists compare the picture observed with a set of standard images to assign a reasonable grade. This process is termed “clinical grading”, or a “subjective” grading system. In order to classify the lens opacity more objectively, experienced human graders assign a grade that best reflects the severity of cortical opacity (i.e. the level of opacity due to cortical cataracts) based on photographs or digital images [5]. This process is termed “grader's grading”, or an “objective” grading system. However, studies have shown that the measurement is still not identical among graders, nor for the same grader at different times [5]. The measurement of the area of opacity is time-consuming as well.

There has been some effort to develop an automatic grading system, to improve grading objectivity. For cortical cataracts and posterior sub-capsular cataracts (PSC), the methods employed so far are rather basic. Nidek EAS-1000 software [6] extracts opacities based on the global threshold principle, with the threshold value picked as 12% from the highest point. There is no distinction between opacity types and pupil detection is manual. The user may manually select the threshold value if automatic detection is not satisfactory. Opacity detection by global thresholding is often inaccurate due to non-uniform illumination of the lens.

An upgraded version of the software [7] detects the pupil automatically as a circle of 95% of the maximal radius detected. A second improvement is that the opacity detection is by contrast-based thresholding. This contrast based approach is unsatisfactory, however, when opacities are so dense that the contrast in the opacified areas is no longer high. The software makes it possible to distinguish between opacity due to cataracts and due to other opacities in a semi-manual process, but not between different sorts of cataracts.

### SUMMARY OF THE INVENTION

The present invention aims to provide an automatic system for detecting a cortical cataract.

In general terms, the invention proposes that a computer system identifies, in an image of a lens, opacity due to cortical cataracts, by
(a) selecting a region of interest in an image of a lens;
(b) processing the region of interest to produce a modified image using an algorithm which emphasizes opacity associated with a cortical cataract relative to opacity caused by other types of opacity, such as opacity caused by at least one other type of cataract.

The results may be used in grading the level of cortical opacity by measuring, in the modified image, the proportion of cortical opacity in at least one area of the region of interest.

Since embodiments of the system are automatic, preferred embodiments make it possible to diagnose cortical cataracts more objectively, and at the same time to save the workload of clinical doctors.

The region of interest (ROI) detection preferably includes detection of edges (i.e. borders of regions with different intensities) within the image, generation of a convex hull including the edges, and then fitting of an ellipse to the convex hull. Edges within the pupil are unlikely to lie on the convex hull, and, if not, are not taken into account during the ellipse fitting. This may make it possible achieve a robust result in the case of severe cataracts.

The detection of the edges may be performed using both Canny and Laplacian edge detection algorithms. Edges which are not extracted by both forms of edge detection are neglected.

The algorithm which emphasizes opacity associated with a cortical cataract relative to other types of opacity, particular opacity caused by posterior sub-capsular cataracts (PSC), includes at least one of the following identification algorithms which is:
(a) an identification algorithm which extracts edges which extend in a generally radial direction in the ROI;
(b) an identification algorithm which extracts the centers of opacities which extend in a generally radial direction in the ROI;
(c) an identification algorithm which extracts edges extending in a generally circumferential direction in the ROI; and
(d) an identification algorithm which extracts the centers of opacities which extend in a generally circumferential direction in the ROI.

Optionally a plurality of identification algorithms of types (a) to (d) are performed. The results of the algorithms are combined in such a way that edges and opacity centers identified by identification algorithm(s) of type (a) and (b) are combined, but so as to reduce the estimated effects of edges and opacity centers identified by identification algorithm(s) of types (c) and (d). For example, the results of an identification algorithm of type (c) or (d) can be used to generate compensation data indicative of expected opacity, the compensation data being used to reduce identified opacity within the image, such as by subtracting the compensation data from data obtained by identification algorithm(s) of types (a) and/or (b).

An example of identification algorithms (b) and (d) is local thresholding using a selection element which is a shape which is elongate in one of the axial or the circumferential directions.

Preferably, at least one identification algorithm of type (a) to (d) is performed having first transformed the image from Cartesian space into polar coordinates relative to an origin obtained from the ROI, and is followed by a re-conversion back into Cartesian space. In this case, the identification algorithms of type (b) and/or (d) may include local thresholding using selection elements aligned in the “horizontal” or “vertical” directions in the polar image. Furthermore, identification algorithms types (a) and/or (c) may include algorithms, such as the Sobel algorithm, which can be used to identify edges in “vertical” or “horizontal” directions in the polar image.

The radial edges and opacity centers, once identified by identification algorithm(s) of type (a) and/or (b), and provided they are not eliminated by data from identification algorithm(s) of type (c) and/or (d), can be used to obtain “seeds” for use in a region growing process, to generate regions corresponding to the opacity associated with these seeds.

Optionally, one or more filtering operations can be performed to remove or weaken data representing features which are not likely to be indicative of cortical cataracts (e.g. specks or regions identified by the embodiment as having a predetermined shape, such as a round shape, or as having a specific location such as proximate the centre of the ROI).

The invention may be expressed either as a method, or an apparatus arranged to perform the method, or as a computer program product (such as a tangible recording medium) carrying program instructions performable by a computer system to perform the method. Further a processor arranged to perform the method can be incorporated into a camera for taking photographs of a lens.

### BRIEF DESCRIPTION OF THE FIGURES

An embodiment of the invention will now be illustrated for the sake of example only with reference to the following drawings, in which:

FIG. 1 is a flow diagram of the automatic grading system which is an embodiment of the present invention;

FIG. 2 illustrates schematically the process of FIG. 1;

FIG. 3 is a flow-diagram of the sub-steps of a ROI detection step in FIG. 1;

FIG. 4 illustrates ROI detection by the embodiment of FIG. 1;

FIG. 5 illustrates two types of opacity due to different types of cataract;

FIG. 6 shows the steps of a process for emphasizing cortical opacity in the embodiment of FIG. 1;

FIG. 7 shows schematically how a typical image is modified in the process of FIG. 6;

FIG. 8 compares an (a) Original image and (b) the result of the process of FIG. 6;

FIG. 9 illustrates (a) a measuring grids, and (b) the result of overlaying such a grid on a lens image such as that of FIG. 8(b); and

FIG. 10 is comparison of automatic cortical opacity area detection performed by the embodiment with that of a human grader.

### DETAILED DESCRIPTION OF THE EMBODIMENTS

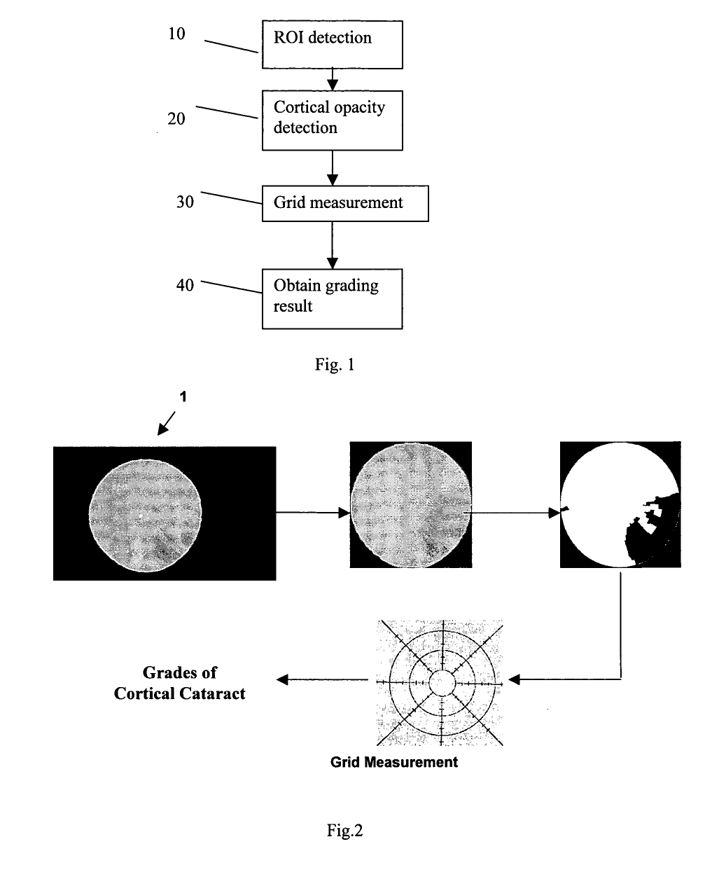

Referring to FIGS. 1 and 2, the steps are illustrated of a software system which is an embodiment of the present invention, and which extracts from lens images the cortical opacity, and grades it. FIG. 1 is a flow diagram of these steps, while FIG. 2 shows the steps schematically, with reference to images representing the results of each step of the process. Corresponding steps of FIGS. 1 and 2 are indicated by the same reference numerals.

The input to the embodiment is an optical image 1, containing a light approximately-circular region which is a pupil, surrounded by a dark border. Opacity is indicated by the darkened region of this pupil.

(i) ROI detection (step 10)

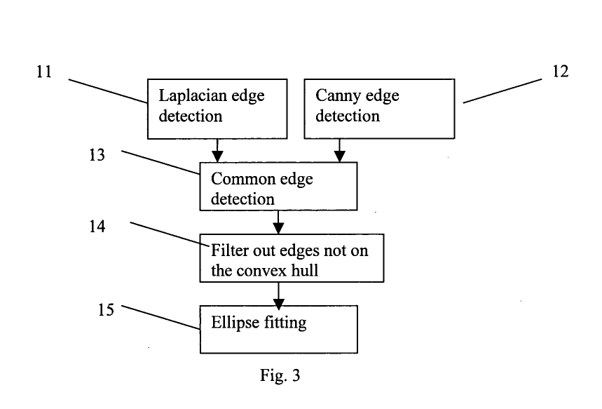

A first step of the method (step 10) is ROI Detection, the sub-steps of which are illustrated in FIG. 3. In a first sub-step 11, the original image 1 is filtered by a Laplacian edge-detection filter and thresholded to obtain the Laplacian edges (a well know algorithm).

In a second sub-step 12, canny edge detection (another well-known algorithm) is applied to the original image to detect the strongest edges. In a third sub-step 13, the edges which are common by both edge detectors are selected, which means that the effects of any external reflective noise are removed. Any edges detected within the lens are removed by a filter sub-step 14, which extracts only edges on the convex hull. This solves the problem of opacity due to a severe cataract creating edges in the image.

Using these edge pixels, in a fifth step 15, non-linear least square fitting by the Gauss-Newton method is applied to extract four parameters defining the best fitted ellipse. This is an iterative approach to determine the four parameters that best fit the sets of edge pixels (xᵢ, yᵢ) to the elliptical equation

y=b±k\sqrt{r²−(x−a)²}.

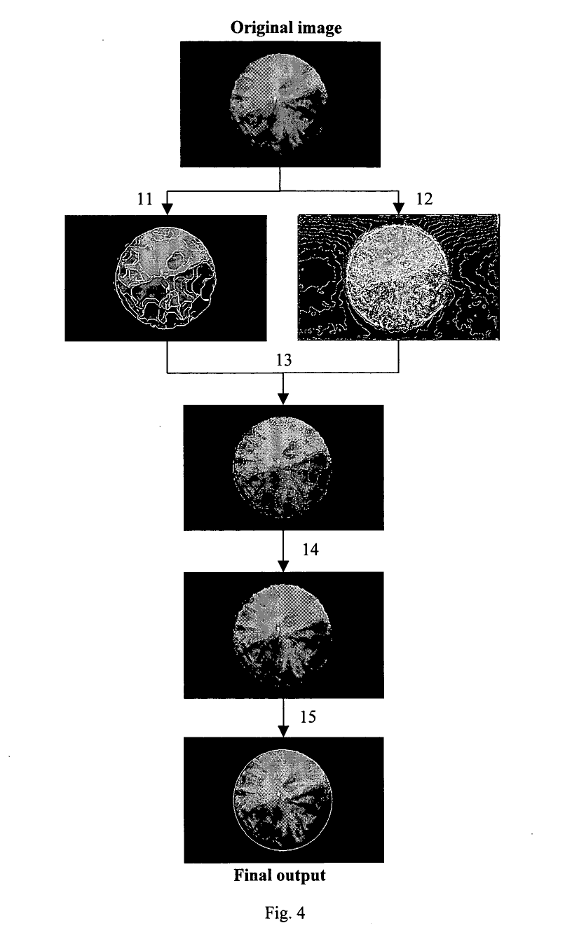

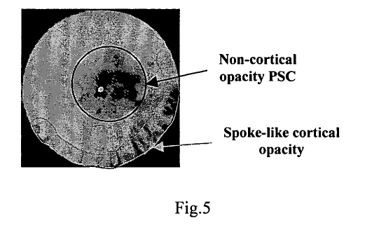

One example of the results of ROI detection 10 is shown in FIG. 4. It shows how original image 10 has been modified following the sub-steps which are illustrated in FIG. 3. Corresponding steps of FIGS. 3 and 4 are indicated by the same reference numerals. As can be seen, the result of ellipse fitting corresponds closely to the outline of the pupil.

(ii) Cortical Opacity Detection (step 20)

Cortical opacities are one of the 3 main types of cataract opacities commonly found on lenses. It is observed that the main difference between cortical cataracts and the remaining cataract types would be the spoke-like nature of cortical cataracts and their location at the rim of the lens. See FIG. 5, for example, where the grey-scale image includes a dark region near the rim of the pupil due to a cortical cataract, and a central opacity region due to a PSC.

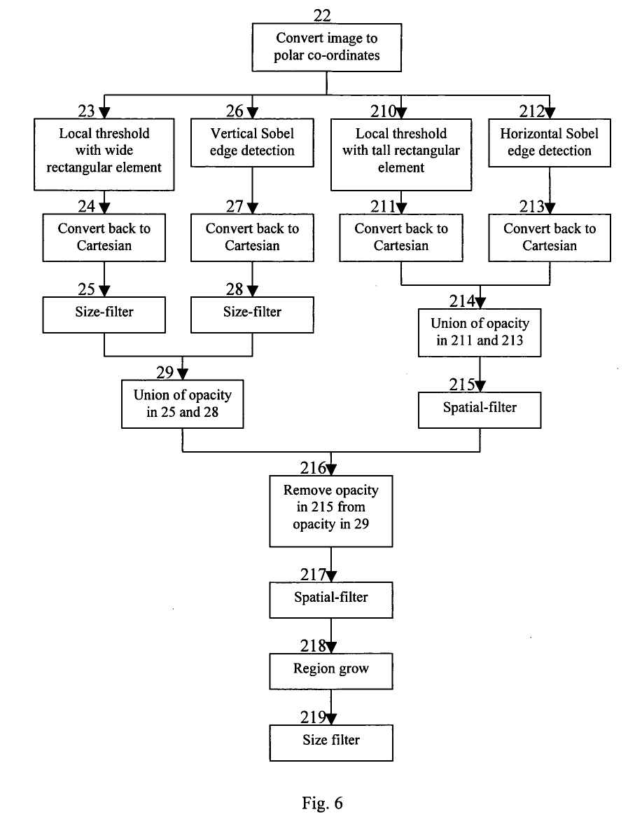

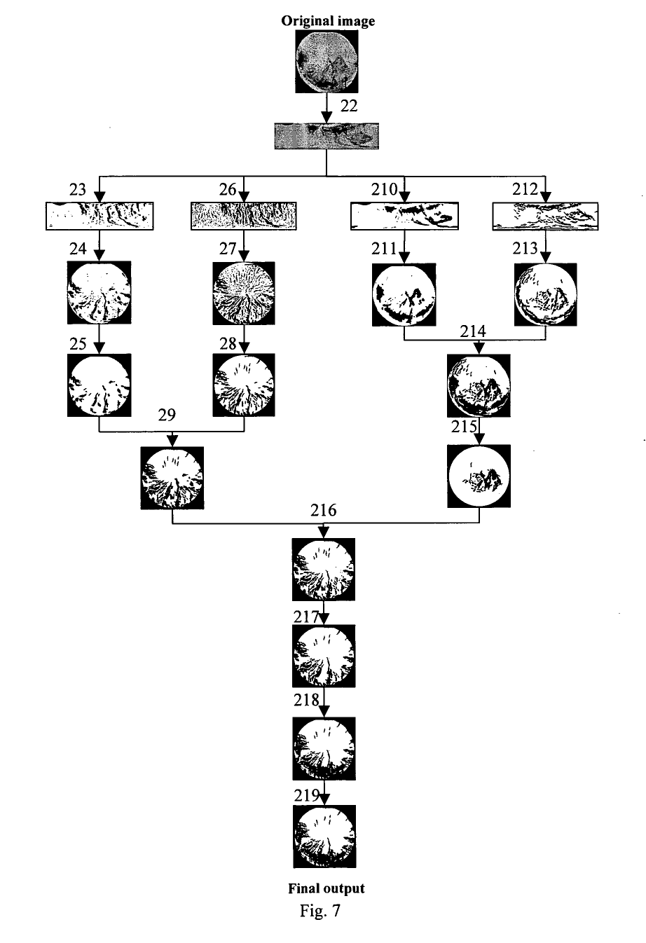

Step 20 of the embodiment employs radial edge detection and region growing to emphasize cortical cataract opacity. The sub-steps are shown in FIG. 6, and the results of the steps are shown schematically in FIG. 7.

In a first sub-step 22, an original image 10 is transformed into polar coordinates. Given the spoke-like nature of cortical opacities, the polar image would ease the processing to extract the cortical edges in the radial direction and rejecting PSC edges in the angular (circumferential) direction.

Sub-steps 23-213 are in four sets: 23-25, 26-28, 210-211 and 212-213. Any of the sets of steps can be performed before or after any other set, or multiple sets can be performed in parallel.

In sub-steps 23-25, we evaluate opacity having a correlation in the radial direction (radial opacity) and representing central portions of cortical cataracts. The term “correlation in the radial direction” can be understood as meaning having a length direction within a certain angular range of the radial direction, or as meaning that there is a statistical correlation between the length direction and the radial direction which is of at least a certain level of statistical significance.

Specifically, in sub-step 23 we process the image using a local threshold with a wide rectangular element to obtain radial opacity. A wide element is selected to provide comparison between each pixel and its horizontally adjacent neighbors, for pixels near the center of spoke-like cortical opacities ideally have a lower intensity value than them. The entire process is accomplished by defining the rectangular element around each pixel and setting the intensity of that pixel to the dark value if the difference between the intensity of the pixel and the mean intensity of the pixels within the rectangular element is less than a threshold. In handling pixels near the edge where the rectangle would overlap the edge, such pixels are considered adjacent to the pixels at the opposite edge of the polar plot.

In sub-step 24, we re-convert the image to Cartesian co-ordinates. In sub-step 25 we use a size-filter to remove small specks that are mostly noise.

Sub-steps 26-28 obtain radial edges to represent outer portions of cortical cataracts. In sub-step 26 we apply Vertical Sobel edge detection to the polar image to detect the edges in the radius direction (radial edges). In sub-step 27, we re-convert the image to Cartesian co-ordinates. In sub-step 28 we use a size-filter to remove small specks that are mostly noise.

Sub-steps 29 the images obtained in steps 25 and 28 are merged, according to the rule: (image 25 AND image 28). Thus, in the merged image it is a white pixel if it is white in both image 25 and image 28.

Sub-steps 210 to 215 identify angular (i.e. not radially-directed) opacity near the centre of the pupil, which is likely to be due to PSC. In step 210, a local thresholding is performed with a tall rectangular element to obtain angular opacity. In step 212, Horizontal Sobel edge detection is applied to the original image. In steps 211 and 213, we re-convert to Cartesian space. In sub-step 214, we merge the central portions of the circumferential edges with the outer portions to obtain angular opacity attributable to PSC opacity.

In step 215, we apply a spatial-filter to remove angular opacity near the rim of lens which may be due to cortical opacity. Spatial filtering is accomplished by eliminating opacity clusters with distances from the lens origin to the centriods being below a fixed ratio of the radius.

In step 216, we merge the images obtained in steps 29 and 215. In the merged image, a pixel is white if it is white in image 29 or black in Image 215. Thus, we retain all possible edges and centres of cortical cataracts, but eliminate PSC.

In step 217, we filter to obtain remaining opacity as seeds for region growing of cortical opacity. Spatial-filtering removes opacities located near the center of the lens which probably belong to PSC.

In step 218, we region grow cortical opacity with the previously obtained seeds. Region growing applied here grows from pixels that are just adjacent to the cluster, and forming the circumference of the cluster. Each pixel in this circumference is compared with a fixed number of pixels within the cluster that is closest to it in the direction of the pixel itself to the centroid of the cluster. Only if the intensity of the pixel is within a fixed threshold to the mean value of the pixels in the cluster will it be considered part of the cluster. Region growing terminates when there is no new pixel according to the growing criteria.

Finally, in step 219 we apply a size filter (as explained above with reference to step 215) to the region-grown areas to eliminate possible overly-extensive outgrowths that may have resulted from rare incidents of cortical opacity with poorly defined edges. For such cases, the ratio of the number of region-grown pixels to that of the original cortical seeds will be exceptionally large, and the grown regions will be voided.

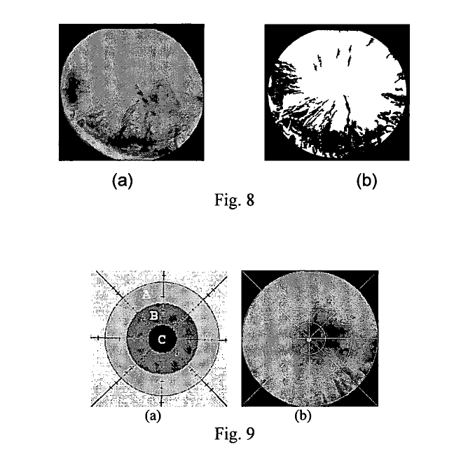

One example of the detection is illustrated in FIG. 8. It can be noted that the system is sensitive to cortical cataracts, but not sensitive to other types of opacity such as PSC.

Note that in other embodiments there are yet further techniques which can be applied to detect cortical opacity in step 20, and the invention is not limited to the techniques described above. Such suitable techniques may include any one or more of:

1. Region Growing with the local minimum as the seeds;

### 2. Local Thresholding;

### 3. Clustering;

4. Level set techniques;
5. Texture analysis;

### 6. Wavelets; and

7. Graph based method.
(ii) Grid measurement (30)

Based on the cortical opacity detected in step 20, in step 30 the embodiment performs automated grading of cortical cataracts, following the Wisconsin cataract grading protocol [5]. A measuring grid is used which divides a lens image into 17 sections, as shown in FIG. 9(a). The grid is formed by three concentric circles: a central circle with radius 2 mm, an inner circle with radius 5 mm, and an outer circle with radius of 8 mm. The regions within the inner circle is referred to as area C, that between the inner and central circle as area B, and between the central and outer circles as area A. Equally spaced radial lines at 10:30, 12:00, 1:30, 3:00, 4:30, 6:00, 7:30, and 9:00 divide the zones between the central and inner circles and between the inner and the outer circles into eight subfields each.

In step 30, the outer circle is aligned with the border of ROI as shown in FIG. 9(b), so that the ROI is overlaid with the grid. The percentage area of the detected cortical opacity (i.e. the output of step 20) in each of areas A, B, and C in FIG. 9(a) is calculated. The total percentage area of cortical opacity is calculated according to the following equation [5]:

Total area %=area % in A*0.0762+area % in B*0.0410+area % in C*0.0625

(iv) Obtain grading result (40)

The grades of cortical cataract are assigned according to the description in the following table.

TABLE 1
Cortical cataract grading protocol

| Grades of Cortical Cataract | Description |
|---|---|
| 1 | Total Area <5% |
| 2 | Total Area 5-25% |
| 3 | Total Area >25% |

### Experimental Results

The embodiment of the automatic opacity detection system was tested using retro-illumination images obtained from a population-based study: The Singapore Malay Eye Study (SiMES). A Scheimpflug retro-illumination camera, Nidek EAS-1000, were used to photograph the lens through the dilated pupil. The retro-illumination images were captured as gray-scale images and were exported from EAS-1000 software. They were saved in the format of bitmap with a size of 640*400 pixels.

Our automatic pupil detection algorithm was tested using 607 images. 607 images were tested and the success rate is 98.2%. The ROI was inaccurately detected for only 11 images, and were due to the heavy presence of reflective noise.

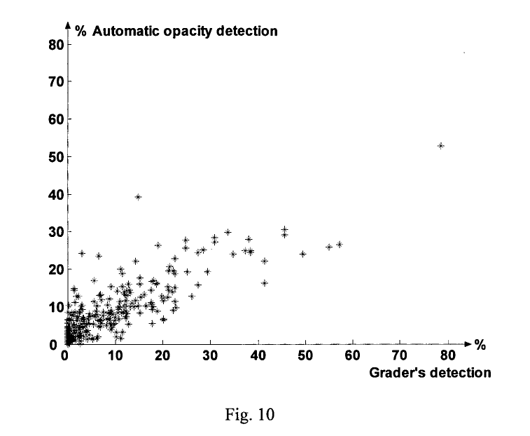

To test the robustness of our cortical opacity detection, 466 images having a human grader's grading result were selected. A comparison was performed with the total area graded by the human grader according to the same protocol. FIG. 10 indicates the comparison results. The mean absolute error is 3.15%.

A comparison between the automated grades of cortical cataract with that of human grader was also carried out. The results are shown in Table 2. The success rate is 85.6%, which we think is promising for automatic grading.

TABLE 2
Comparison with the grader's grades

| | Automated | | |
|---|---|---|---|
| Graders | Grades | | |
| grades | 1 | 2 | 3 |
| 1 | 277 | 38 | 0 |
| 2 | 15 | 109 | 4 |
| 3 | 0 | 10 | 13 |

A comparison between our system and two prior art systems is summarized in Table 3.

TABLE 3
Comparison with two prior art systems

| | | | Distinction | |
|---|---|---|---|---|
| | Technology | Automatic | between | |
| | of opacity | pupil | opacity | |
| | detection | detection | types | Limitation |
| Nidek | Global | No | No | Often inaccurate |
| EAS-1000 | thresholding | | | due to non- |
| [6] | | | | uniform |
| | | | | illumination |
| The prior | Contrast | Yes | No | Contrast in the |
| Art in [7] | based | | | opacified areas |
| | thresholding | | | is no longer high |
| | | | | when opacities |
| | | | | are dense |
| Our System | Radial edge | Yes | Yes | |
| | detection | | | |

### REFERENCES

[1] WHO, Magnitude and Causes of Visual Impairment, http://www.who.int/mediacentre/factsheets/fs282/en/index.html, 2002.
[2] T. Y. Wong, S. C. Loon, S. M. Saw, “The Epidemiology of Age Related Eye Diseases in Asia,” Br. J. Ophthalmol., Vol. 90, pp. 506-511, 2006.
[3] P. Mitchell, R. G. Cumming, K. Attebo, J. Panchapakesan, “Prevalence of Cataract in Australia: the Blue Mountains Eye Study,” Ophthalmology, Vol. 104, pp. 581-588, 1997.
[4] S. K. Seah, T. Y. Wong, P. J. Foster, T. P. Ng, G. J. Johnson, “Prevalence of Lens Opacity in Chinese Residents of Singapore: the Tanjong Pagar Survey,” Ophthalmology, Vol. 109, pp. 2058-2064, 2002.
[5] B. E. K. Klein, R. Klein, K. L. P. Linton, Y. L. Magli, M. W. Neider, “Assessment of Cataracts from Photographs in the Beaver Dam Eye Study,” Ophthalmology, Vol. 97, No. 11, pp. 1428-1433, 1990.
[6] Nidek Co. Ltd, Anterior Eye Segment Analysis System: EAS-1000. Operator's Manual, Nidek, Japan 1991.
[7] A Gershenzon, L. D Robman, “New Software for Lens Retro-illumination Digital Image Aanalysis,” Australian and New Zealand Journal of Ophthalmology, Vol. 27, pp. 170-172, 1999.

What is claimed is:

1. A method performed by a computer system for grading of cortical cataracts includes:
(a) selecting a region of interest in an image of a lens;
(b) processing the region of interest to produce a modified image using a cortical opacity emphasis algorithm which is sensitive to cortical cataracts but not sensitive to other tyres of opacity.

2. A method according to claim 1 in which the region of interest (ROI) detection includes detecting of edges within the image, generation of a convex hull including the edges, and fitting of an ellipse to the convex hull.

3. A method according to claim 2 in which the detection of the edges is performed by at least two different edge detection algorithms and edges which are not detected by multiple said edge detection algorithms are neglected.

4. A method according to claim 1 in which the said cortical opacity emphasis algorithm includes at least one identification algorithm which is:
(a) an identification algorithm which extracts edges which extend in a generally radial direction in the ROI;
(b) an identification algorithm which extracts the centers of opacities which extend in a generally radial direction in the ROI;
(c) an identification algorithm which extracts edges extending in a generally circumferential direction in the ROI; and
(d) an identification algorithm which extracts the centers of opacities which extend in a generally circumferential direction in the ROI.

5. A method according to claim 4 in which there are a plurality of said identification algorithms, and said cortical opacity emphasis algorithm includes combining results obtained by said identification algorithms.

6. A method according to claim 5 in which results identified by said identification algorithm(s) of type (a) and/or (b) are combined constructively, but are reduced using results identified by said algorithm(s) of types (c) and/or (d).

7. A method according to claim 4 including at least one said identification algorithm of types (b) or (d) which is local thresholding using a selection element which is aligned either in the axial or the circumferential direction.

8. A method according to claim 4 in which at least one of said identification algorithms is performed having first transformed said image of the eye from Cartesian space into polar coordinates relative to an origin obtained from the ROI.

9. A method according to claim 8 in which at least one identification algorithm of type (b) and at least one identification algorithm of type (d) include local thresholding using respective selection elements aligned respectively in the “vertical” or “horizontal” directions in the polar image.

10. A method according to claim 8 in which at least one identification algorithm of type (a) or at least one identification algorithm of type (c) include a Sobel algorithm to identify edges in the polar image.

11. A method according to claim 4 in which the results identified by identification algorithm(s) of type (a) and/or (b), and which are not eliminated based on data from identification algorithms(s) of type (c) and/or (d), are subject to a region growing operation.

12. A method according to claim 11 in which the edges and opacity centers obtained by said identification algorithms are used to obtain seeds for use in said region growing operation.

13. A method according to claim 11 including a filtering operation to remove or weaken data representing features which are not indicative of cortical cataracts according to one or more criteria based on size, shape or location.

14. A method of grading cortical opacity in an image of the eye comprising detecting cortical opacity by a method according to claim 1, then grading the level of cortical opacity by measuring, in the modified image, the proportion of opacity in at least one area of the region of interest.

15. A computer system having a processor arranged to perform a method for grading of cortical cataracts, the method including:
(a) selecting in an image of a lens
(b) processing the region of interest to produce a modified image using a cortical opacity emphasis algorithm which is sensitive to cortical cataracts but not sensitive to other types of opacity.

16. A computer program product, readable by a computer and containing instructions operable by a processor of a computer and containing instructions operable by a processor of a computer system to cause the processor to perform a method for grading of cortical cataracts, the method including:
(a) selecting a region of interest in an image of a lens;
(b) processing the region of interest to produce a modified image using a cortical opacity emphasis algorithm which is sensitive to cortical cataracts but not sensitive to other types of opacity.
